(19) United States
(12) Patent Application Publication
(10) Pub. No.: US 2016/0241893 A1
(43) Pub. Date: Aug. 18, 2016

(54) Media Player Including Automatic Configuration

(71) Applicant: Fire-FX, LLC, Round Rock, TX (US)

(72) Inventors: Lawrence William Allhands, Round Rock, TX (US); Kenneth Edward Allhands, Linden, MI (US)

(73) Assignee: FIRE-FX, LLC, Round Rock, TX (US)

(21) Appl. No.: 14/744,075

(22) Filed: Jun. 19, 2015

Related U.S. Application Data
(60) Provisional application No. 62/117,348, filed on Feb. 17, 2015.

(51) Int. Cl. H04N 21/241; H04N 21/434; H04N 21/858; H04L 29/08; H04N 21/226

(52) U.S. Cl. CPC H04N 21/241; H04L 67/16; H04N 21/2265; H04N 21/8586; H04N 21/4345

(57) ABSTRACT

In some embodiments, a media player may include a first interface configured to communicate with a network and a controller coupled to the first interface. The controller may be configured to automatically detect a hub device through the network and to automatically map a shared volume of the hub device to a local drive mapping in response to detecting the media server.

### CROSS-REFERENCE TO RELATED APPLICATION(S)

The present disclosure claims priority to and is a non-provisional application of co-pending U.S. Provisional Patent Application No. 62/117,348, filed on Feb. 17, 2015, and entitled “A Method for Automated Configuration of Media Players and Media Server over a Switched Network”, which is incorporated herein by reference in its entirety.

### FIELD

The present disclosure is generally related to home entertainment systems, and more particularly, to self-configuring media players configured to automatically discover and couple to a hub device.

### BACKGROUND

A home entertainment system may include a network configured to couple one or more media players with a hub device such that the media player(s) and the hub device are in communication over the network. The hub device may include, for example, a digital video recorder (DVR), and may have access to media content, such as movies, audio data, television data, other data, or any combination thereof. The media player(s) may communicate with the hub device through the network to retrieve media content and to play or reproduce the media content at a display device.

### SUMMARY

In some embodiments, a method may include automatically detecting a media server coupled to a network using a controller of a media player. The method may also include automatically mapping a shared volume of the media server to a local drive letter at the media player in response to detecting the media server.

In some embodiments, a media player may include a first interface configured to communicate with a network and a controller coupled to the first interface. The controller may be configured to automatically detect a hub device through the network and to automatically map a shared volume of the hub device to a local drive mapping in response to detecting the media server.

In still other embodiments, a data storage device, data storage medium, or computer-readable device may include instructions that, when executed by a controller of a media player, cause the media player to automatically detect a media server coupled to a network. The instructions may further cause the media player to automatically map a shared volume of the media server to a local drive letter at the media player in response to detecting the media server.

### BRIEF DESCRIPTION OF THE DRAWINGS

FIG. 1 is an example flowchart of a method of automatically configuring a media player according to certain embodiments of the present disclosure.

FIG. 2 is a block diagram of a home entertainment system including a media player configured to automatically configure itself, in accordance with some embodiments of the present disclosure.

FIG. 3 is a block diagram of a hub device of a home entertainment system in accordance with some embodiments of the present disclosure.

FIG. 4 is a block diagram of a media player configured to automatically configure itself, in accordance with some embodiments of the present disclosure.

FIG. 5 is an example illustration of communications between a media player and a hub device according to certain embodiments of the present disclosure.

FIG. 6 is an example flowchart of a method of automatically configuring a media player according to certain embodiments of the disclosure.

In the various figures, reference numerals may be reused to indicate the same or similar elements in the various embodiments.

### DETAILED DESCRIPTION OF ILLUSTRATIVE EMBODIMENTS

In the following detailed description of embodiments, reference is made to the accompanying drawings which form a part hereof, and which are shown by way of illustrations. Features of various described embodiments may be combined, other embodiments may be utilized, and structural changes may be made without departing from the scope of the present disclosure. Also, features of the various embodiments and examples herein can be combined, exchanged, or removed without departing from the scope of the present disclosure.

In accordance with various embodiments, the methods and functions described herein may be implemented as one or more software programs, which may be executed by a processor. In some embodiments, the methods and operations may be implemented by a circuit, such as a field programmable gate array (FPGA), a controller, or any combination thereof. Dedicated hardware implementations including, but not limited to, application specific integrated circuits, programmable logic arrays, and other hardware devices can likewise be constructed to implement the methods and functions described herein. Further, the methods described herein may be implemented as a device, such as a computer readable storage medium or memory device, including instructions that when executed cause a processor to perform the methods.

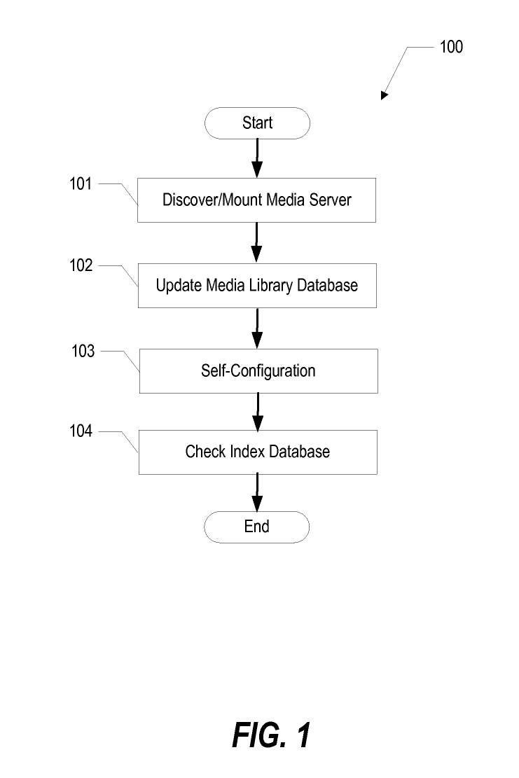

Embodiments of devices, systems, and methods are described below that may include a self-configuring media player configured to automatically connect to a media content server on a network and to provide an interface through which a user may selectively play one or more media files from the media content server. In some embodiments, the media content server may store movies, television programs, images, music, and other data and may stream selected content to the media player in response to a request. In some embodiments, when the media player is coupled to a network and activated, the media player may perform a detection operation to detect a server device (such as a hub device). When the media player detects the server device, the media player may automatically mount a shared volume from the server device and, in some embodiments, may also register itself with the server device. One possible example of a system including one or more media players configured to self-register is described below with respect to FIG. 1.

FIG. 1 is an example flowchart of a method 100 according to certain embodiments of the present disclosure. The method 100 allows users to add media players to a network including a hub device, for example, a media server, without having to manually configure the media player or the hub device. In some embodiments, the media player may be an electronic device configured to deliver media content to a display device (such as a television, a computing device, or another electronic device having a display. The media server or hub device may be a media content source, such as a digital video recorder device, having media content (such as movies, audio files, images, text, or any combination thereof) that may be streamed to a media player for playback.

When coupled to a network to which a hub device is already coupled, a media player may automatically discover and mount a volume of the media server, at 101. In some embodiments, the media player may scan the network for the hub device, such as by sending queries to one or more devices coupled to the network. In some embodiments, the media player may ping multiple Internet Protocol (IP) addresses associated with the network, and may send a query to each IP address to attempt to identify the hub device. In some embodiments, the media player may detect the hub device based on a response to the query. In some embodiments, in response to detecting the hub device, the media player may mount a shared volume of the hub device by mapping the shared volume to a local drive.

At 102, the media player updates its media library database with data from a media database located on the hub device. In some embodiments, the media player may store a list of available media content in its media library database, which may be used to provide an electronic program guide to a display from which a user may select particular media content for playback.

At 103, the media player then self-configures, utilizing information found from the network identification and scan, updating web links (in its browser interface) to point to hub device services and updating local configuration files to include the hub device address information. In some embodiments, this self-configuration may be part of the automatic discovery and mounting of the volume described above at 101.

Once successfully configured, the media player checks to see if its name or other identification is listed in the hub device's configuration index database, at 104. The hub device's configuration index database may be accessible through the mounted volume. In some embodiments, the configuration index database may be a flat file, such as a text file, which may store a list of registered devices. If the media player determines that its identifier is not in the list, the media player may write its configuration data to the configuration index database.

The media player may be configured to perform a self-configuration operation, making the device plug-and-play with respect to a media content network. This self-configuring media player makes it possible for non-technical users to easily add the media player to an established home entertainment system with minimal guidance or technical ability, saving valuable time and effort by automating the set-up process.

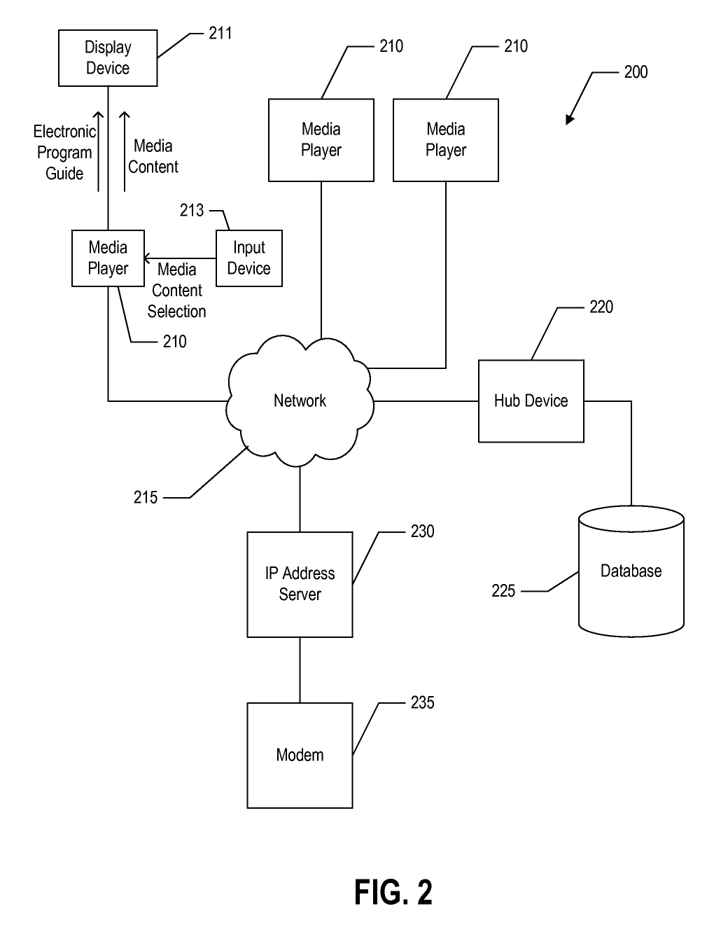

Embodiments of a home entertainment system are described below that may include a device, such as the above-described media player, which may be configured to automatically configure itself, and to automatically register itself with a hub device of the home entertainment system through a network. The media player may automatically configure itself, for example, by detecting the hub device over the network, automatically determining media content stored by the hub device, and automatically mounting a network drive at the media player that is mapped to a shared volume that stores the media content. Further, in certain embodiments, the media player may automatically register itself with the hub device, if, for example, the media player is not yet registered with the hub device. One possible example of a system including a self-configuring media player is described below with respect to FIG. 2.

FIG. 2 is a block diagram of a home entertainment system 200 including media players and a hub device, according to some embodiments. The home entertainment system 200 can include a plurality of media players 210 coupled to a hub device 220 through a network 215. At least one of the media players 210 may be coupled to a display device 211, such as a television. The media player 210 may provide an electronic program guide (EPG) to the display device 211. A user may view the EPG on the display device 211 and may provide a media content selection to the media player 210 via an input device 213, such as a remote control, a smart phone, or another electronic device configured to communicate with the media player 210. In response to the media content selection, the media player 210 may retrieve the media content from the hub device 220 and may provide the media content to the display device 211.

The system 200 may further include an Internet Protocol (IP) address server 230 coupled to the network 215. The home entertainment system 200 may further include a database 225 coupled to the hub device 220. In some embodiments, the hub device 220 includes the database 225. Additionally, the home entertainment system 200 may include a modem 235 configured to couple one or more of the hub 220, the media players 210, or any combination thereof to a wide area network, such as the Internet. In some embodiments, the IP address server 230 may be part of the modem 235.

The database 225 may store media content, such as audio data, movie data, television data, image data, text data, other data, or any combination thereof. While a single database 225 is shown in FIG. 2, the hub device 220 may be coupled to multiple databases. In some embodiments, different databases may store different types of media content. In one example of a home entertainment system, the media players 210 may be located in different rooms in a house, and the hub device 220 may also be located in the house. The hub device 220 and the media players 210 may communicate through a network 215 to access and reproduce (for example, download and play) media content retrieved from the database 225. For example, a user may interact with the media player 210 (such as by using an associated remote control to access an electronic program guide providing a list of media content from which to select) to access media content in the database 225 through the hub device 220 over the network 215, allowing the media player 210 to remotely access media content to initiate a download and to reproduce the media content at an associated display.

In some embodiments, upon installation, the media player 210 may be configured to automatically detect the hub device 220 and to automatically map a shared volume of the hub device to a local drive letter, mounting the network drive for access to data stored at that location of the hub device 220 (such as media content from the database 225). The media player 210 may automatically register itself with the hub device 220, by checking a configuration index at the hub device 220 to see if an identifier associated with the media player 210 is in the configuration index. If the identifier is missing from the configuration index, the media player 210 may add identifier information to the configuration index to register itself with the hub device 220. This self-configuration by the media player may eliminate the need for manual configuration of the media player 210 with the hub device 220.

In an example embodiment, when a media player 210 is coupled to the network 215, the media player 210 may acquire an IP address from the IP address server 230. Once the media player 210 is coupled to the network 215, the media player 210 may sweep or scan network addresses of devices coupled to the network 215 to detect the hub device 220. To scan, the media player 210 may send queries to IP addresses of the network 215 and may monitor the responses to detect a hub device 220 network. The network scan or sweep performed by the added media player 210 allows the media player 210 to detect the hub device 220 on the network 215 without the need for a user to manually program the (network) address of the hub device 220 into the media player 210, thereby automating installation and interoperability of the media player 210 with the home entertainment system 200.

In response to detecting the hub device 220, the media player 210 may automatically determine a shared volume of the hub device and may map the shared volume to a local drive letter of the media player to mount the shared volume. The media player 210 may then access the mounted volume to determine available media content. Further, the media player may check a list of registered devices that is maintained by the hub device 220 and that may be accessible via the shared volume to determine if it is already registered with the hub device 220. If the media player 210 is not already registered with the hub device 220, the media player 210 may register itself with the hub device 220 by writing an identifier and optionally other information into the list. Registration of the media player 210 with the hub device 220 may be subject to an authentication process performed by the hub device 220. By automatically mounting the shared volume and by automatically registering itself with the hub device 220, the media player 210 may reduce or eliminate manual programming of the media player 210 and the hub device 220, thereby automating installation and interoperability of the media player 210 with the home entertainment system 200.

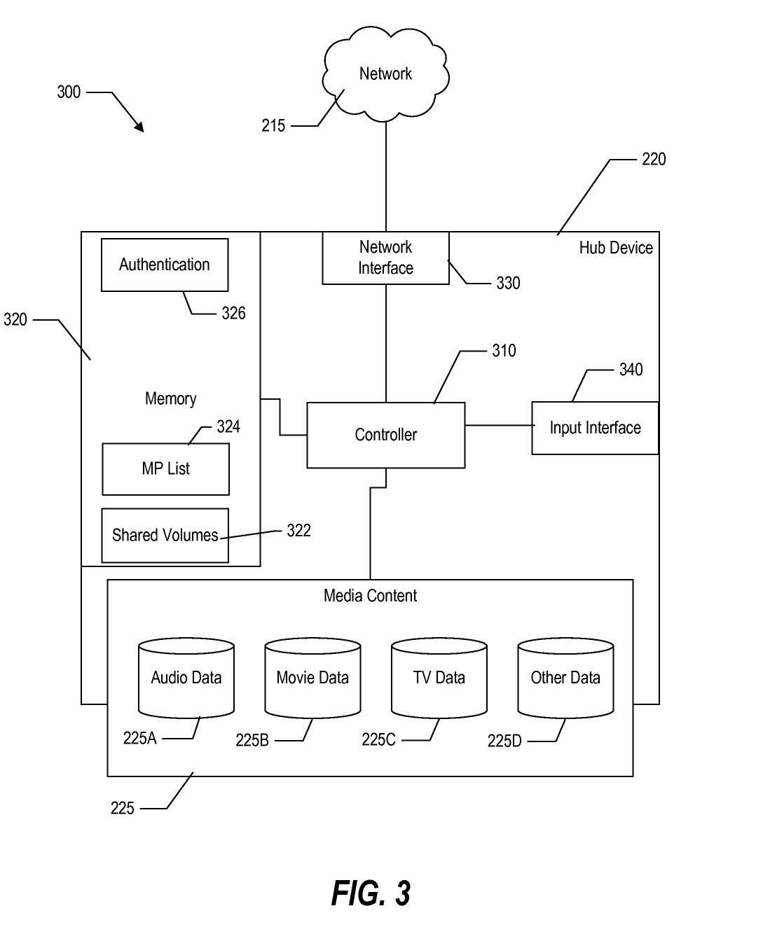

Referring now to FIG. 3, a block diagram of a system 300 including the hub device 220 is shown according to some embodiments. The hub device 220 can include a controller 310 coupled to a memory 320, to a network interface 330, and to a user interface 340. In some embodiments, the controller 310 may include a processor, a field programmable gate array, a logic circuit, another circuit, or any combination thereof. The hub device 220 may be coupled to or may include a database 225. The controller 310 may also be coupled to the network interface 330, which may be coupled to the network 215. The controller 310 may receive input data from the input interface 340, which input data may be used to configure and control the hub device 220. In some embodiments, the input interface 340 may include buttons accessible by a user to interact with the hub device 220. In some embodiments, the input interface 340 may include a transceiver configured to receive radio frequency (RF) signals, infrared signals, other wireless signals, or any combination thereof from a remote control device configured to communicate with the hub device 220, such as a programmable remote control for use with televisions, video recorder devices, stereo systems, and other electronic playback devices, or such as a portable computing device (e.g., a laptop computer, a smart phone, or another computing device).

The database 225 may include media content, which media players may access and reproduce. The media content may include audio data 225A, movie data 225B, television data 225C, and other data 225D. The database(s) 225 may be coupled to the controller 310. The hub device 220 may be configured to receive a request for media content from a media player 210, to retrieve the media content corresponding to the request from the database 225, and to stream the media content to the media player 210, such that the media players 210 may access audio, movies, TV and other data for reproduction at a display associated with the media player 210.

According to some embodiments, the memory 320 may include a shared volumes list 322, a media player list 324, and an authentication routine 326. The shared volumes list 322 may include information about the database(s) 225 and the media content stored in the database(s) 225. The media player list 324 may include identifiers corresponding to media players 210 registered with the hub device 220. The authentication routine 326 may include a routine executable by the controller 310 to authenticate a request from a media player 210.

The hub device 220 may receive a query from a media player 210 via the network 215. The query may correspond to a hub detection operation executed by the media player 210, and the query may include a request for a response from the hub device 220. In some embodiments, the hub device 220 may respond with a simple acknowledgment. In some embodiments, the hub device 220 may respond with network address and shared volume information.

In some embodiments, the hub device 220 may also receive a media query or valid network media shares test signal from the media player 210. In response to the test signal, the hub device 220 may send a media response indicating shared volumes or media shares available at the hub device 220, or other data, such as shared volumes data 322. The media response may also include link information for the services and libraries available through the hub device 220.

In some embodiments, the scan (detection) signal, the valid network media shares test signal, or both may include information about the requesting media player 210. In some embodiments, the controller 310 may utilize the authentication instructions 326 from the memory 320 to process the information to determine whether the media player 210 is authorized to access the media content in database(s) 225. The hub device 220 may communicate data related to those shared volumes to which the media player 210 has access, and may omit data related to the other volumes based on the authentication instructions 326.

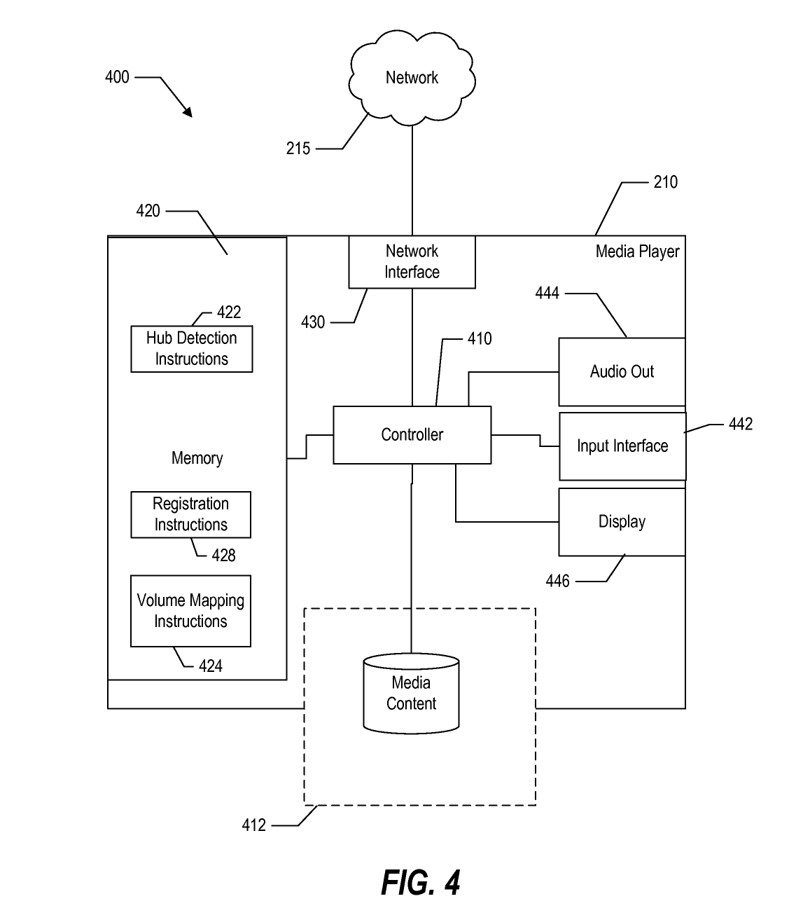

Referring now to FIG. 4, a block diagram of a system 400 including a media player 210 is shown according to some embodiments. The media player 210 may include a controller 410 coupled to a memory 420, to a network interface 430, and to other interfaces, such as an input interface 442, an audio output interface 444, and a display interface 446. The input interface 442 may include a set of controls accessible by a user, such as buttons, a touchscreen interface, or other user-accessible features. In some embodiments, the input interface 442 may include a transceiver configured to receive input data from a remote control device. The media player 210 may output media content to the audio out interface 444, the display interface 446, another interface, or any combination thereof. The media player 210 may be coupled to a database 225 of the hub device 220 via one or more mapped network volumes 412.

In some embodiments, the controller 410 may receive input from the input interface 442. The controller 410 may utilize the received input to configure and control the media player 210.

According to some embodiments, the memory 420 may include a hub detection instructions 422 that, when executed, may cause the controller 410 to perform a detection operation to detect the hub device 220 through the network 215. The hub detection instructions 422 may cause the controller 410 to send one or more signals through the network 215 to one or more network addresses and to detect the hub device 220 based on a received response. The memory 420 may further include volume mapping instructions 424 that, when executed, cause the controller 410 to map a shared volume of the hub device 220 to a local drive of the media player 210. The memory 420 may further include registration instructions 428 that, when executed, cause the controller 410 to check a registered device list stored by the hub device 220 and to add information to the registered device list when the media player 210 is not identified in the registered device list.

When the media player 210 is coupled to the network 215 and powered on, the controller 410 may access the memory 420 and execute the hub detection instructions 422 to detect a hub device 220 coupled to the network 215. For example, running the hub detection instructions 422 may cause the controller 410 to send queries via the network interface 430 through the network 215 requesting a response from a hub device 220, and the media player 210 may detect a hub device on the network 215 based on received responses.

In response to receiving a response from the hub device 220, the controller 410 may access and run the volume mapping instructions 424 in the memory 420. The volume mapping instructions 424 may cause the media player 210 to communicate with the hub device 220 over the network 215 to map a shared volume of the hub device 220 to a local drive letter at the media player 210. In some embodiments, the volume mount routine 424, when executed, may cause the controller 410 to send a media query to the hub device 220 and to receive a media response indicating the media content supported or hosted by the hub device 220.

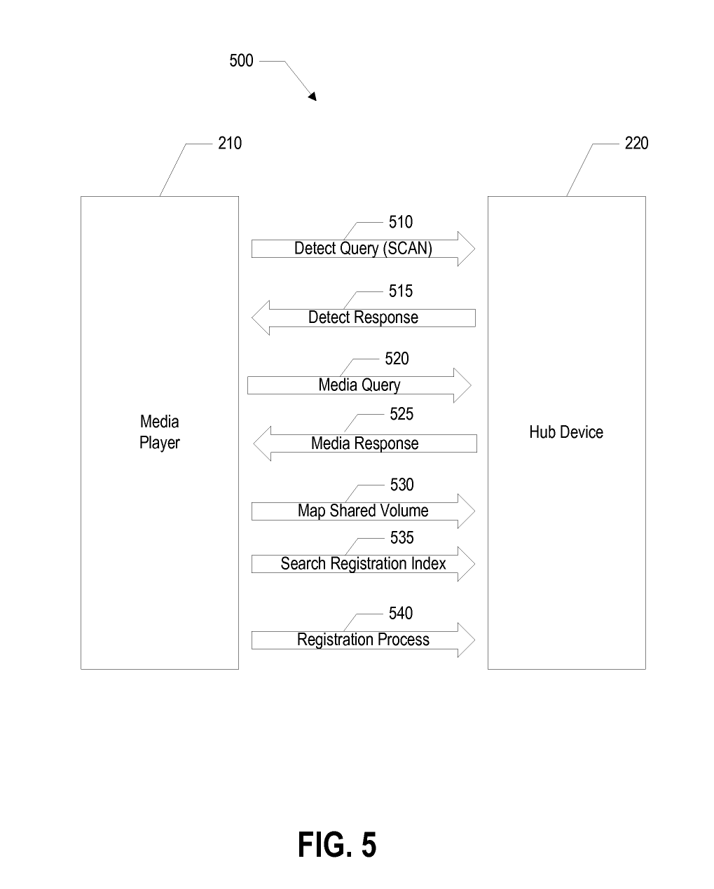

Referring now to FIG. 5, a diagram 500 of communications between a media player 210 and a hub device 220 is shown according to some embodiments. When powered on, at 510, as part of a boot sequence, the media player 210 may send hub device detect queries through the network to various IP addresses. In some embodiments, the detect queries may be scans or packets configured to elicit a response from a hub device 220, and the media player 210 may be able to detect the hub device 220 based on the response.

When the hub device 220 receives a detect query, the hub device 220 may respond, at 515. In some embodiments, the response may include information about the hub device 220, such as address information (media access control (MAC), IP address, subnet information, and so on), media content information, other information, or any combination thereof.

In response to receiving the detect response from the hub device 220, the media player 210 can send a media query to the hub device 220. In some embodiments, the media query may cause the hub device 220 respond with an indication of the media supported by the hub device 220. In some embodiments, the media query may ask the hub device for a list of shared volumes. In some embodiments, the media query may include authentication information, which may be used by the hub device 220 to determine which, if any, shared volumes may be accessed by the media player 210.

At 525, the hub device 220 may provide a media response to the media player 210. In some embodiments, the media response may include an indication of the media supported by the hub device 220. In some embodiments, the media response may include data identifying one or more databases including media content.

At 530, the media player 210 may map the shared volume of the hub device 220 to a local drive letter. In some embodiments, the media player 210 may access the shared volume of the hub device 220 via the local drive letter. At 535, the media player 210 may access the local drive letter to search a registration index stored at the hub device 220. In some embodiments, the media player may search the registration index for an identifier corresponding to the media player 210.

If the media player 210 is already registered in the registration index, the media player 210 may continue with its boot process. Otherwise, at 540, the media player 210 may perform a registration process. In some embodiments, the media player 210 may register itself with the hub device 220 by adding identifying information to the registration index. In some embodiments, the media player 210 may write an identifier corresponding to the media player 210 in the registration index of the hub device 220.

In some embodiments, a method may include automatically configuring a media player 210 based on network information and the at least one response associated with a hub device 220. Automatically configuring the media player 210 may include automatically updating one or more web links of a web browser interface of the media player 210 to correspond to services available at the media server (hub device 220), and automatically updating local configuration files of the media player 210 with address information corresponding to the media server (hub device 220). In some embodiments, the method may further include automatically checking to determine if configuration data associated with the media player 210 is included in a registration index of the media server (hub device 220), and when the configuration data is not included in the registration index, the method may include automatically writing data associated with the media player to the registration index.

In some embodiments, the media player 210 may include a first interface (such as a network interface) configured to communicate with a hub device 220 and may include a controller coupled to the first interface. In some embodiments, the controller of the media player 210 may be configured to automatically detect the hub device 220 via the first interface and automatically map a shared volume of the hub device 220 to a local drive mapping in response to the detection.

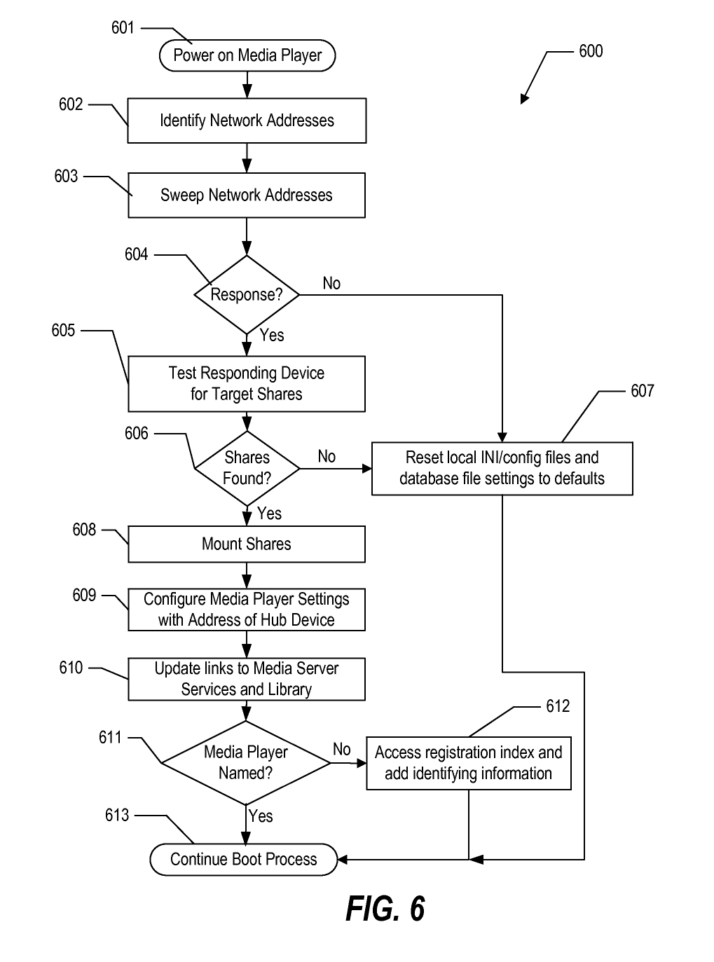

FIG. 6 is an example flowchart of a method 600 of automatically configuring a media player according to certain embodiments of the disclosure. At 602, the method 600 may include powering on the media player. In some embodiments, the method 600 at 602 may also include coupling the media player to a network (wired or wireless).

The method 600 may further include identifying one or more network addresses, at 602. In some embodiments, media player may receive a network address from an IP server and may determine or calculate a list of IP addresses of the network. The method 600 may also include sweeping or scanning the network addresses, at 603. In some embodiments, the process of sweeping or scanning the network addresses may include pinging, signaling, or otherwise communicating with the various IP addresses and monitoring responses to detect a hub device. In some embodiments, the responses may be analyzed by the media player and a hub device may be detected based on at least one of the responses.

At 604, if no response is received from a network address, the method 600 advances to 607 and the media player resets local initialization (INI) files and configuration (config) files and sets database file settings to default settings. The method 600 then proceeds to 613 to continue a boot process.

Otherwise, at 604, if a response is received, the method 600 proceeds to 605 and the responding device is tested for target shares. In an example, the media player may communicate with the responding device to determine if the responding device has shared volumes of media content. At 606, if no shares are found, the method 600 may advance to 607 and the local initialization (INI) files and the configuration (config) files may be reset, and the database file setting may be reset to default settings. The method 600 then proceeds to 613 to continue a boot process.

Otherwise, at 606, if target shares are found, the method 600 may proceed to 608 and the shares may be mounted. In some embodiments, the media player may mount the target shares by mapping each target share to a local drive letter. If multiple shared volumes are present, one or more of the shared volumes may be mounted locally. In some embodiments, the media player may have limited access, and only those shared volumes accessible to the particular media player (such as based on access permissions) may be mapped to a local drive, and others may be ignored. In some embodiments, a media player for a kid's room, for example, may have restricted access to media content, such as when adult content is stored in one shared volume while family friendly content is stored in another. In such an instance, the media player may map the shared volume containing the family friendly content.

At 609, the method 600 includes configuring the media player settings with the address of the hub device. In some embodiments, the media player may automatically update its server settings.

At 610, the method 600 may include updating links to the media server services and library of the hub device. In a particular example, the media player may update its links to the services and the libraries of the hub device. At 611, the method 600 may include checking to if a media player is named (identified) in a registration list or index. If not, the method 600 may include accessing the registration index and adding identifying information corresponding to the media player. In some embodiments, the identifying information may include a media access control identifier, an IP address, a device name, a serial number, another identifier, or any combination thereof. In some embodiments, the identifier may be unique to the media player as compared to other media players. The method 600 advances to 613 to continue the boot process. Otherwise, at 611, if the media player is already named in the registration index, the method 600 advances to 613 to continue the boot process.

In conjunction with the systems, devices, and methods described above with respect to FIGS. 1-6, a system may include a media content server (a hub device) and at least one media player. The media player may be configured to automatically detect the media content server, to map a shared media content volume to a local drive letter at the media player, and to register with the media content server. In some embodiments, the media player may be configured to provide plug-and-play functionality with respect to a media content server, allowing a user to couple a media player to a network and to access media content from the server via the media player without having to manually configure the media player. In a particular example, the media player may automatically discover and couple to the media content server and may configure itself to provide selected media content to a display device.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
automatically detecting a media server coupled to a network using a controller of a media player; and
automatically mapping a shared volume of the media server to a local drive letter at the media player in response to detecting the media server.

2. The method of claim 1, wherein automatically detecting comprises:
automatically determining network information from the network;
selectively scanning network addresses of the network via the media player;
receiving at least one response at the media player in response to scanning; and
detecting the media server based on the at least one response.

3. The method of claim 2, further comprising automatically configuring the media player based on the network information and the at least one response.

4. The method of claim 3, wherein automatically configuring the media player comprises:
automatically updating one or more web links of a web browser interface of the media player to correspond to services available at the media server; and
automatically updating local configuration files with address information corresponding to the media server.

5. The method of claim 1, further comprising automatically checking, using the controller, a registration index of the media server to determine if an identifier corresponding to the media player is included.

6. The method of claim 5, further comprising, when the identifier is not included, writing identifying information to the registration index using the controller.

7. The method of claim 1, further comprising:
providing, to a display device, an electronic program guide including a list of available media content corresponding to media content available from the media server;
receiving a media content selection corresponding to an item within the electronic program guide at an interface of the media player;
retrieving the media content corresponding to the media content selection from the media server via the drive mapping in response to receiving the media content selection; and
providing the selected media content to the display device.

8. A media player comprising:
a first interface configured to communicate with a network; and
a controller coupled to the first interface and configured to:
automatically detect a hub device through the network; and
automatically map a shared volume of the hub device to a local drive in response to detecting the media server.

9. The media player of claim 8, wherein the controller is configured to:
automatically determine network information from a network via the first interface;
selectively scan network addresses of the network to detect the hub device; and
automatically detect the hub device based on a response to the scan.

10. The media player of claim 9, wherein the controller is further configured to:
automatically configure update one or more web links of a web browser interface to correspond to services available at the hub device; and
automatically update local configuration files with address information corresponding to the hub device.

11. The media player of claim 8, wherein the controller is further configured to automatically determine if identifying data associated with the media player is included in a registration index at the hub device.

12. The media player of claim 11, wherein the controller is further configured to automatically write the identifying data to the registration index when the identifying data is not included in the registration index.

13. The media player of claim 8, further comprising:
a second interface coupled to the controller;
a third interface coupled to the controller; and
wherein the controller is further configured to:
provide an electronic program guide to the second interface, the electronic program guide including a list of media content stored at the hub device;
receive a media content selection corresponding to an item in the electronic program guide at the third interface;
retrieve the selected media content corresponding to the media content selection from the hub device via the drive mapping in response to the media content selection; and
provide the selected media content to the second interface.

14. A computer readable device comprises instructions that, when executed by a controller of a media player, cause to the media player to:
automatically detect a media server coupled to a network; and
automatically map a shared volume of the media server to a local drive letter at the media player in response to detecting the media server.

15. The computer readable device of claim 14, wherein the instruction, when executed, cause the media player to automatically detect the media server by:
automatically determining network information;
selectively scanning network addresses of the network via the media player; and
detecting the media server based on at least one response received at the media player.

16. The computer readable device of claim 15, further comprising instructions that when executed by the controller, cause the media player to automatically configure settings of the media player based on the network information and the at least one response.

17. The computer readable device of claim 16, wherein the instructions that, when executed, cause the media player to automatically configures its settings, include instructions that cause the media player to:
automatically update links of the media player to services available at the media server; and
automatically update local configuration files with address information corresponding to the media server.

18. The computer readable device of claim 14, further including instructions that, when executed, cause the media player to automatically determine if identifying data associated with the media player is included in a registration index of the media server.

19. The computer readable device of claim 18, further comprising instructions that, when the configuration data is not included in the registration index, cause the media player to automatically write the identifying data to the registration index.

20. The computer readable device of claim 19, further comprising instructions that, when executed, cause the media player to:
generate an electronic program guide corresponding to media content available from the media server by accessing data available through the drive mapping; and
provide the electronic program guide to a display device.
